(19) United States
(12) Patent Application Publication
(10) Pub. No.: US 2008/0259458 A1
(43) Pub. Date: Oct. 23, 2008

(54) EUV diffractive optical element for semiconductor wafer lithography and method for making same

(75) Inventors: Bruno M. LaFontaine, Pleasanton, CA (US); Ryoung-Han Kim, San Jose, CA (US); Jongwook Kye, Pleasanton, CA (US)

Correspondence Address: FARJAMI & FARJAMI LLP, 26522 LA ALAMEDA AVENUE, SUITE 360, MISSION VIEJO, CA, 92691, US

(73) Assignee: Advanced Micro Devices, Inc.

(21) Appl. No.: 11/788,355

(22) Filed: Apr. 18, 2007

(51) Int. Cl. G02B 5/18

(52) U.S. Cl. 359/576; 359/569

(57) ABSTRACT

According to one exemplary embodiment, an EUV (extreme ultraviolet) optical element in a light path between an EUV light source and a semiconductor wafer includes a reflective film having a number of bilayers. The reflective film includes a pattern, where the pattern causes a change in incident EUV light from the EUV light source, thereby controlling illumination at a pupil plane of an EUV projection optic to form a printed field on the semiconductor wafer. The EUV optical element can be utilized in an EUV lithographic process to fabricate a semiconductor die.

### 1. TECHNICAL FIELD

The present invention is generally in the field of semiconductor fabrication. More particularly, the invention is in the field of lithographic patterning of semiconductor wafers.

### 2. BACKGROUND ART

During semiconductor wafer fabrication, extreme ultraviolet (EUV) light can be utilized in a lithographic process to enable transfer of very small lithographic patterns, such as nanometer-scale lithographic patterns, from a lithographic mask to a semiconductor wafer. In EUV lithography, a pattern formed on a lithographic mask can be transferred to the semiconductor wafer by exposing a photoresist formed on the semiconductor wafer to EUV light reflected from the lithographic mask. In some situations, it is desirable to use non-conventional illumination, such as dipole, annular or quadrupole illumination, to produce the lithographic image used to define the semiconductor die on the wafer.

A conventional method for producing non-conventional illumination in an EUV lithography scanner involves the use of an aperture plate situated in a plane which is a conjugate of the pupil plane of the EUV projection optics. However, the aperture plate can block a significant amount of EUV light, thereby causing an undesirable reduction in the amount of EUV light that is available for pattern transfer in an EUV lithographic process.

### SUMMARY

An EUV diffractive optical element for semiconductor wafer lithography and method for making same, substantially as shown in and/or described in connection with at least one of the figures, as set forth more completely in the claims.

### BRIEF DESCRIPTION OF THE DRAWINGS

FIG. 1 illustrates a diagram of an exemplary EUV lithographic system including an exemplary EUV diffractive optical element, in accordance with one embodiment of the present invention.

FIG. 2A illustrates a top view of an exemplary EUV diffractive optical element in accordance with one embodiment of the present invention.

FIG. 2B illustrates a cross-sectional view of the exemplary EUV diffractive optical element of FIG. 2A.

FIG. 3 illustrates a top view of an exemplary non-conventional illumination pattern at a semiconductor die provided by the exemplary EUV diffractive optical element of FIGS. 2A and 2B.

FIG. 4 illustrates a diagram of an exemplary EUV lithographic system including an exemplary EUV diffractive optical element, in accordance with one embodiment of the present invention.

FIG. 5 illustrates a diagram of an exemplary electronic system using an exemplary chip or die fabricated with an EUV diffractive optical element in an EUV lithographic process in accordance with one embodiment of the present invention.

### DETAILED DESCRIPTION OF THE INVENTION

The present invention is directed to an EUV diffractive optical element for semiconductor wafer lithography and method for making same. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention.

The drawings in the present application and their accompanying detailed description are directed to merely exemplary embodiments of the invention. To maintain brevity, other embodiments of the present invention are not specifically described in the present application and are not specifically illustrated by the present drawings.

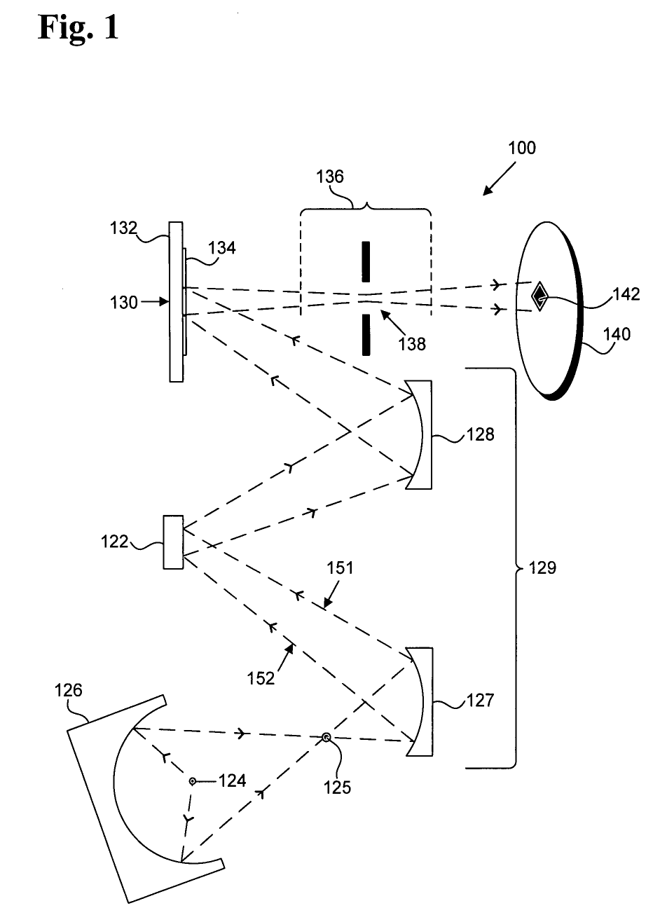

FIG. 1 shows a diagram of an exemplary EUV (extreme ultraviolet) lithographic system including an exemplary EUV diffractive optical element in operation with an exemplary semiconductor wafer in accordance with one embodiment of the present invention. EUV lithographic system 100 includes EUV light source 124, collector 126, illuminator 129, which includes EUV diffractive optical element 122 and illuminator mirrors 127 and 128, lithographic mask 130, which includes mask pattern 134 and substrate 132, and EUV projection optic 136, which includes pupil plane 138. EUV lithographic system 100 is shown in combination with semiconductor wafer 140, which can include a number of semiconductor dies (not shown in FIG. 1). It is noted that illuminator 129 may contain additional mirrors, which are not shown in FIG. 1 for purposes of brevity and simplicity of illustration. It is also noted that EUV projection optic 136 can include a number of optical elements, such as lenses and/or mirrors, which are also not shown in FIG. 1 for the above stated purposes.

As shown in FIG. 1, EUV light source 124, which can be a plasma light source, for example, provides EUV light that is focused and redirected by collector 126 along a light path, which is indicated by broken lines 151 and 152. Also shown in FIG. 1, the EUV light from collector 126 is relayed at intermediate focus 125, which re-images EUV light source 124, and reflected to EUV diffractive optical element 122 by illuminator mirror 127. EUV diffractive optical element 122 is located in the light path between EUV light source 124 and semiconductor wafer 140. EUV diffractive optical element 122 includes a pattern (not shown in FIG. 1) formed in a reflective film (also not shown in FIG. 1), which is utilized to form non-conventional illumination at pupil plane 138 of EUV projection optic 136 for projection onto semiconductor wafer 140.

Further shown in FIG. 1, EUV light diffractively reflected by EUV diffractive optical element 122 is reflected by illuminator mirror 128 to mask pattern 134 on lithographic mask 130. Mask pattern 134 can be formed over a reflective layer (not shown in FIG. 1), which can be formed over substrate 132. Also shown in FIG. 1, EUV light that is reflected off of lithographic mask 130 can be projected by EUV projection optic 136 onto resist-coated semiconductor wafer 140 to form printed field 142 by utilizing an EUV lithographic tool in an EUV lithographic process.

Further shown in FIG. 1, printed field 142, which can comprise a lithographic image of mask pattern 134, can be formed on one or more semiconductor dies (not shown in FIG. 1) situated on and fabricated concurrently with semiconductor wafer 140. The one or more semiconductor dies (not shown in FIG. 1) that are included within printed field 142 can each be a microprocessor die, a memory array or other types of integrated circuits known in the art. The semiconductor dies within printed field 142 can be separated from semiconductor wafer 140 in a dicing process after fabrication of semiconductor wafer 140 has been completed. The diced and separate dies can be packaged, i.e. can be enclosed and/or sealed in suitable semiconductor packages, as known in the art.

During an EUV lithographic process, a non-conventional (i.e. other than a circular intensity distribution representing an image of the source) illumination caused by EUV diffractive optical element 122 can be provided at optical plane 138 of EUV projection optic 136 and transmitted to a semiconductor die on semiconductor wafer 140. The non-conventional illumination thus described can be produced as a result of constructive and destructive interference of EUV light reflected from EUV diffractive optical element 122.

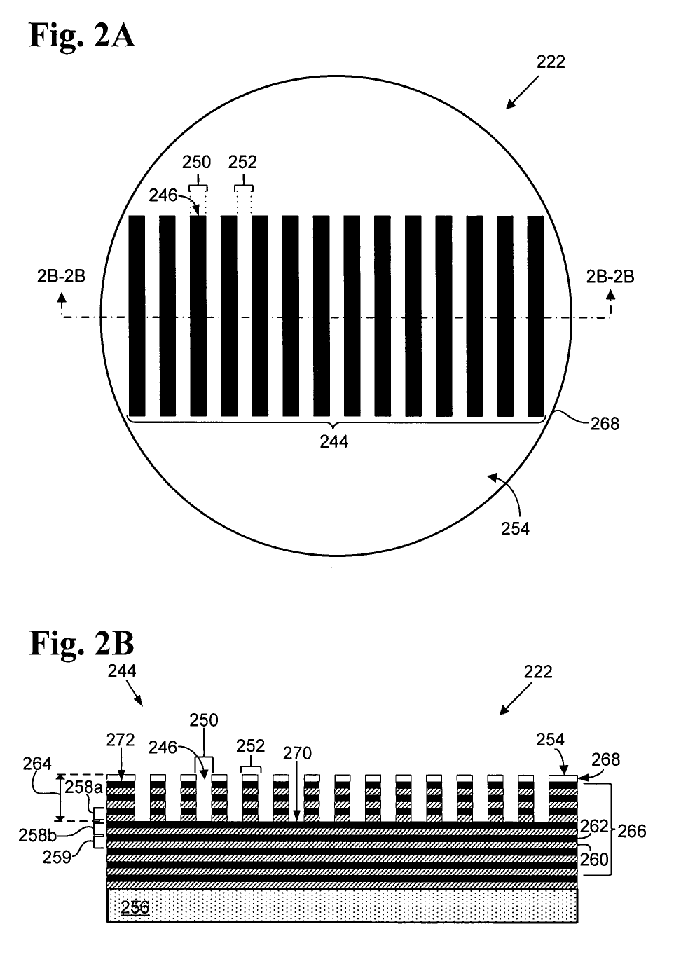

In contrast, conventional techniques for providing non-conventional illumination for EUV lithography typically utilize an aperture plate, which is placed in the EUV light path. However, the aperture plate provides non-conventional illumination by blocking a portion of the incident EUV light, which undesirably reduces the intensity of the non-conventional illumination provided by the aperture plate. Thus, by providing non-conventional illumination without blocking a portion of incident EUV light, the present invention's EUV diffractive optical element advantageously provides non-conventional illumination having greater intensity compared to non-conventional illumination provided by a conventional aperture plate. EUV diffractive optical element 122 will be further discussed below in relation to FIGS. 2A and 2B.

FIG. 2A shows a top view of EUV diffractive optical element 222, which corresponds to EUV diffractive optical element 122 in FIG. 1. EUV diffractive optical element 222 in FIG. 2A includes pattern 244, which includes regions 246, capping layer 268, a reflective film (not shown in FIG. 2A), and a substrate (also not shown in FIG. 2A). As shown in FIG. 2A, regions 246 extend through capping layer 268, which has top surface 268, and into a reflective film (not shown in FIG. 2A) and have width 250. In the present embodiment, regions 246 each have a rectangular shape. In another embodiment, regions 246 can each have a shape other than a rectangle. Pattern 244 forms a diffraction grating, where adjacent regions 246 are separated by distance 252, which determines the “pitch” of the diffraction grating.

FIG. 2B shows a cross-sectional view of EUV optical element 222 across line 2B-2B in FIG. 2A. In particular, regions 246, width 250, distance 252, capping layer 268 correspond to the same elements in FIG. 2A and FIG. 2B. In addition to regions 246 and capping layer 268 shown in FIG. 2A, EUV diffractive optical element 222 also includes substrate 256 and reflective film 266.

As shown in FIG. 2B, reflective film 266 is situated over substrate 256 and can comprise a stack of bilayers, such as bilayers 258a and 258b, for reflecting EUV light. For example, reflective film 266 can comprise a stack that includes more than fifty bilayers. Each bilayer, such as bilayers 258a and 258b, comprises top layer 262 and bottom layer 260 and has thickness 259. For example, bottom layer 260 can comprise molybdenum and top layer 262 can comprise silicon. For example, thickness 259 can be approximately equal to ½ of the wavelength of EUV light, which is approximately 6.7 nanometers. Substrate 256 can comprise doped silica, titanium silicate, or other suitable material having an ultra-low thermal expansion co-efficient.

Also shown in FIG. 2B, capping layer 268 is situated over reflective film 266 and can comprise, for example, a thin layer of silicon or ruthenium. The thickness of capping layer 268 can be selected so as to allow EUV light to pass through it (i.e. capping layer 268) without significantly reducing EUV light transmittance. Further shown in FIG. 2B, each of regions 246 extend through capping layer 268 and bilayer 258a to depth 264, which is the distance between top surface 254 of capping layer 268 and top surface 270 of bilayer 258a. In the preferred embodiment, regions 246 of pattern 244 may extend through several bilayers of the reflective film. In the present embodiment, regions 246 of pattern 244 can be formed by utilizing a suitable etch process to etch through capping layer 268 and an appropriate number of bilayers of reflective film 266. In other embodiments, the invention's EUV diffractive optical element can include a pattern for changing the phase and/or amplitude of incident EUV light, where the pattern can include regions, such as regions 246, which can be formed in the pattern by utilizing a fabrication process such as lithography, film deposition, lift-off, or direct patterning.

In an EUV lithographic process, which can be performed in an EUV lithographic tool, for example, EUV diffractive optical element 222 can provide a desired illumination pattern at the pupil plane of an EUV projection optic, as a result of phase shifting of incident EUV light caused by pattern 244. For example, EUV light incident on EUV diffractive optical element 222 and reflected from pattern 244 is phase shifted relative to EUV light reflected from top surface 272 of reflective film 266. Constructive and destructive interference of the reflected EUV light from EUV diffractive optical element 222 can cause the reflected light to be diffracted in such a way as to produce non-conventional illumination (e.g., a 180-degree phase grating will result in diffracted light in the +1 and −1 orders while suppressing the 0^{th} order, thus producing dipole illumination at the pupil plane of the EUV projection optic), such as a dipole illumination pattern, to be formed at semiconductor wafer 140.

In another embodiment, the pattern formed on EUV diffractive optical element 222 can include one or more concentric etched rings surrounding an etched circle. Each concentric etched ring and the etched circle can extend through one or more bilayers of the reflective film so as to form an annular illumination pattern at the pupil of the EUV projection optic. Thus, by controlling the geometry of the pattern formed on the EUV diffractive optical element, the invention's EUV diffractive optical element can provide different corresponding non-conventional illumination patterns at a semiconductor die on a semiconductor wafer with minimal loss in light intensity.

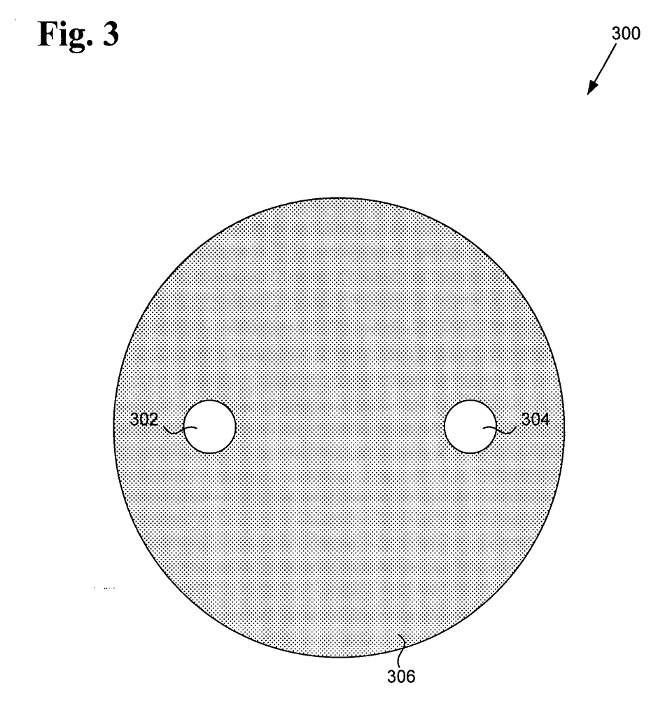

FIG. 3 shows a top view of an illumination pattern produced at the pupil of the EUV projection optic by EUV diffractive optical element 222 in FIGS. 2A and 2B. Illumination pattern 300, which forms a dipole illumination pattern, includes illuminated regions 302 and 304 and non-illuminated region 306. Illumination pattern 300 can be formed at pupil plane 138 of EUV projection optic 136 in FIG. 1 and used to form printed field 142, i.e., a printed image corresponding to mask pattern 134 of lithographic mask 130 in FIG. 1, on a semiconductor die on semiconductor wafer 140.

Illumination pattern 300 can be formed at the pupil plane of the EUV projection optic as a result of the interaction between incident EUV light and pattern 244 on EUV diffractive optical element 222 in FIGS. 2A and 2B. For example, illumination pattern 342 including illuminated regions 302 and 304 and non-illuminated region 306 can be formed as a result of constructive and destructive interference of EUV light diffracted by pattern 244 appearing on exemplary EUV diffractive optical element 222 in FIGS. 2A and 2B.

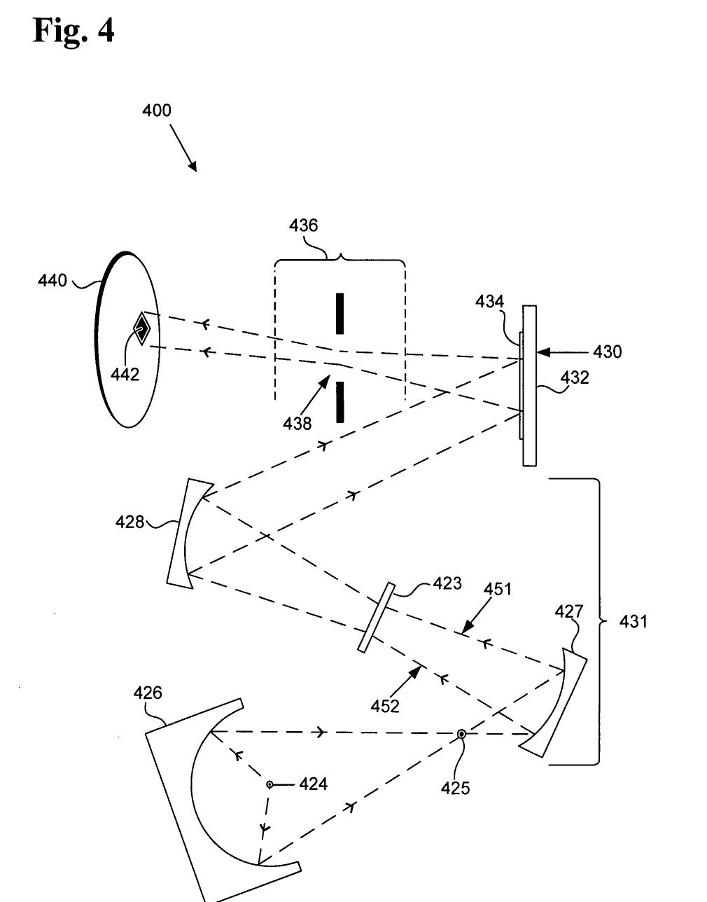

FIG. 4 shows a diagram of an exemplary EUV (extreme ultraviolet) lithographic system including an exemplary EUV diffractive optical element in operation with an exemplary semiconductor wafer in accordance with one embodiment of the present invention. In FIG. 4, EUV light source 424, collector 426, illuminator mirrors 427 and 428, lithographic mask 430, which includes mask pattern 434 and substrate 432, EUV projection optic 436, which includes pupil plane 438, in EUV lithographic system 400 correspond, respectively, to EUV light source 124, collector 126, illuminator mirrors 127 and 128, lithographic mask 130, which includes mask pattern 134 and substrate 132, EUV projection optic 136, which includes pupil plane 138, in EUV lithographic system 100 in FIG. 1. EUV lithographic system 400 is shown in combination with semiconductor wafer 440, which can include a number of semiconductor dies (not shown in FIG. 4).

As shown in FIG. 4, illuminator 431 in EUV lithographic system 400 includes EUV diffractive optical element 423 and illuminator mirrors 427 and 428. EUV diffractive optical element 423 is located in a light path, which is indicated by broken lines 451 and 452, between EUV light source 424 and semiconductor wafer 440. In the embodiment in FIG. 4, EUV diffractive optical element 423 can comprise a transmissive film (not shown in FIG. 4) including a pattern (also not shown in FIG. 4), such as pattern 244 on EUV diffractive optical element 222 in the embodiment in FIGS. 2A and 2B, for changing the phase and/or amplitude of incident EUV light. The pattern (not shown in FIG. 4) on the transmissive film (also not shown in FIG. 4) of EUV diffractive optical element 423 can diffract incident EUV light and generate a controlled non-conventional illumination pattern at pupil plane 438 of EUV projection optic 436. In one embodiment, the pattern (not shown in FIG. 4) on EUV diffractive optical element 423 can be etched in the transmissive film by using a suitable etch process. In other embodiments, the pattern on the transmissive film in EUV diffractive optical 423 can be formed by utilizing a fabrication process such as lithography, film deposition, lift-off, or direct patterning. The thickness of EUV diffractive optical element 423 can be selected so as to allow an adequate amount of EUV light to be transmitted through it.

Thus, EUV diffractive optical element 423 includes a pattern (not shown in FIG. 4) formed in a transmission film (also not shown in FIG. 4), where the pattern is utilized to control non-conventional illumination at pupil plane 438 of EUV projection optic 436 to form printed field 442 on semiconductor wafer 440. Printed field 442, which is projected onto semiconductor wafer 440 by EUV projection optic 436, can include a printed image of mask pattern 434, which is formed on lithographic mask 430.

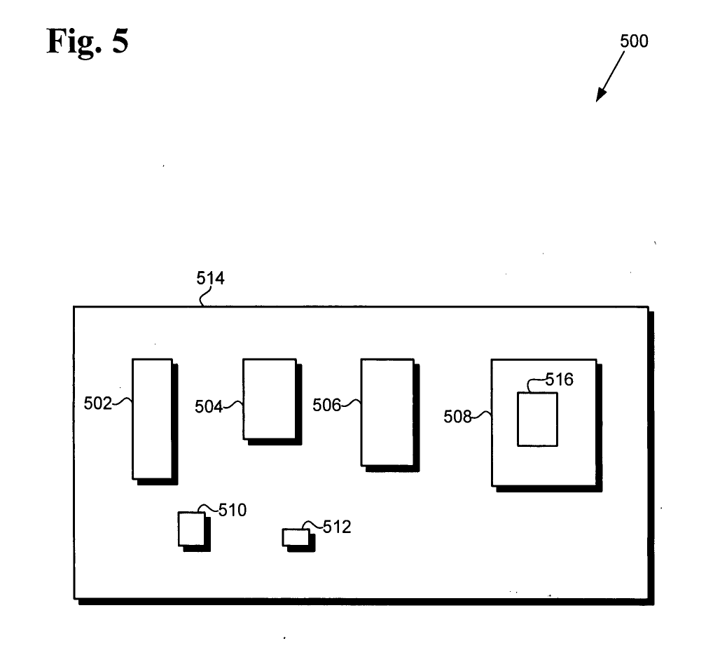

FIG. 5 illustrates a diagram of an exemplary electronic system including an exemplary chip or die fabricated using an EUV diffractive optical element for semiconductor wafer lithography in accordance with one or more embodiments of the present invention. Electronic system 500 includes exemplary modules 502, 504, and 506, IC chip 508, discrete components 510 and 512, residing in and interconnected through circuit board 514. In one embodiment, electronic system 500 may include more than one circuit board. IC chip 508 can comprise a semiconductor die which is fabricated by using an embodiment of the invention's EUV diffractive optical element, such as EUV diffractive optical element 222 in FIGS. 1, 2A, and 2B or EUV diffractive optical element 423 in FIG. 4, in an EUV lithographic process performed in an EUV lithographic tool. IC chip 508 includes circuit 516, which can be a microprocessor, for example.

As shown in FIG. 5, modules 502, 504, and 506 are mounted on circuit board 514 and can each be, for example, a central processing unit (CPU), a graphics controller, a digital signal processor (DSP), an application specific integrated circuit (ASIC), a video processing module, an audio processing module, an RF receiver, an RF transmitter, an image sensor module, a power control module, an electromechanical motor control module, or a field programmable gate array (FPGA), or any other kind of module utilized in modern electronic circuit boards. Circuit board 514 can include a number of interconnect traces (not shown in FIG. 5) for interconnecting modules 502, 504, and 506, discrete components 510 and 512, and IC chip 508.

Also shown in FIG. 5, IC chip 508 is mounted on circuit board 514 and can comprise, for example, any semiconductor die that is fabricated by utilizing an embodiment of the invention's EUV diffractive optical element to provide non-conventional illumination at an pupil plane in an EUV projection optic for projection of a printed field on the semiconductor die in an EUV lithographic process. In one embodiment, IC chip 508 may not be mounted on circuit board 514, and may be interconnected with other modules on different circuit boards. Further shown in FIG. 5, discrete components 510 and 512 are mounted on circuit board 514 and can each be, for example, a discrete filter, such as one including a BAW or SAW filter or the like, a power amplifier or an operational amplifier, a semiconductor device, such as a transistor or a diode or the like, an antenna element, an inductor, a capacitor, or a resistor.

Electronic system 500 can be utilized in, for example, a wired communications device, a wireless communications device, a cell phone, a switching device, a router, a repeater, a codec, a LAN, a WLAN, a Bluetooth enabled device, a digital camera, a digital audio player and/or recorder, a digital video player and/or recorder, a computer, a monitor, a television set, a satellite set top box, a cable modem, a digital automotive control system, a digitally-controlled home appliance, a printer, a copier, a digital audio or video receiver, an RF transceiver, a personal digital assistant (PDA), a digital game playing device, a digital testing and/or measuring device, a digital avionics device, a medical device, or a digitally-controlled medical equipment, or in any other kind of system, device, component or module utilized in modern electronics applications.

Thus, the present invention provides an EUV diffractive optical element including a pattern for controlling non-conventional illumination at a pupil plane of an EUV projection optic to form a printed field on a semiconductor wafer in an EUV lithographic process during semiconductor wafer fabrication. For example, the invention's EUV diffractive optical element can advantageously provide desired non-conventional illumination, such as a dipole illumination pattern, at the pupil plane of the EUV projection optic. Also, the invention's EUV diffractive optical element can provide a non-conventional illumination pattern without blocking a portion of incident EUV light, which occurs in previous techniques that utilize an aperture plate to provide non-conventional illumination. As result, the invention's EUV diffractive optical element can advantageously provide a desired non-conventional illumination having increased intensity at a semiconductor die compared to the non-conventional illumination provided by an aperture plate in a previous or usual approach.

From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

Thus, an EUV diffractive optical element for semiconductor wafer lithography and method for making same have been described.

1. An EUV (extreme ultraviolet) diffractive optical element in a light path between an EUV light source and a semiconductor wafer, said EUV diffractive optical element comprising:
a reflective film having a plurality of bilayers;
said reflective film including a pattern;
said pattern causing a change in incident EUV light from said EUV light source, thereby controlling illumination at a pupil plane of an EUV projection optic to form a printed field on said semiconductor wafer.

2. The EUV diffractive optical element of claim 1, wherein said pattern is formed by a fabrication process selected from the group consisting of lithography, film deposition, etching, lift-off, and direct patterning.

3. The EUV diffractive optical element of claim 1, wherein said pattern is etched through one or more of said plurality of bilayers of said reflective film.

4. The EUV diffractive optical element of claim 1, wherein said EUV diffractive optical element is utilized in an EUV lithographic process to fabricate a semiconductor die.

5. The EUV diffractive optical element of claim 1, wherein each of said plurality of bilayers comprises a top layer situated over a bottom layer, wherein said top layer comprises silicon.

6. The EUV diffractive optical element of claim 5, wherein said bottom layer comprises molybdenum.

7. The EUV diffractive optical element of claim 1, wherein each of said plurality of bilayers has a thickness approximately equal to ½ of a wavelength of EUV light.

8. The EUV diffractive optical element of claim 1, wherein said plurality of bilayers is greater than 50.

9. The semiconductor die of claim 4, wherein said semiconductor die is utilized in a circuit board.

10. An EUV (extreme ultraviolet) diffractive optical element in a light path between an EUV light source and a semiconductor wafer, said EUV diffractive optical element comprising:
a transmissive film including a pattern;
said pattern diffracting incident EUV light and generating a controlled illumination pattern at a pupil plane of an EUV projection optic to form a printed image on said semiconductor wafer.

11. The EUV diffractive optical element of claim 10, wherein said pattern is formed by utilizing a fabrication process selected from the group consisting of lithography, film deposition, etching, lift-off, and direct patterning.

12. The EUV diffractive optical element of claim 10, wherein said EUV diffractive optical element is utilized in an EUV lithographic process to fabricate a semiconductor die.

13. The semiconductor die of claim 12, wherein said semiconductor die is utilized in a circuit board as a part of an electronic system, said electronic system being selected from the group consisting of a wired communications device, a wireless communications device, a cell phone, a switching device, a router, a repeater, a codec, a LAN, a WLAN, a Bluetooth enabled device, a digital camera, a digital audio player and/or recorder, a digital video player and/or recorder, a computer, a monitor, a television set, a satellite set top box, a cable modem, a digital automotive control system, a digitally-controlled home appliance, a printer, a copier, a digital audio or video receiver, an RF transceiver, a personal digital assistant (PDA), a digital game playing device, a digital testing and/or measuring device, a digital avionics device, a medical device, and a digitally-controlled medical equipment.

14. A semiconductor die fabricated by utilizing an EUV diffractive optical element positioned in a light path between an EUV light source and a semiconductor wafer, said EUV diffractive optical element comprising:
a reflective film having a plurality of bilayers;
said reflective film including a pattern;
said pattern causing a change in incident EUV light from said EUV light source, thereby controlling illumination at a pupil plane of an EUV projection optic to form a printed field on said semiconductor wafer.

15. The EUV diffractive optical element of claim 14, wherein said pattern is formed by a fabrication process selected from the group consisting of lithography, film deposition, etching, lift-off, and direct patterning.

16. The EUV diffractive optical element of claim 14, wherein said pattern is etched through one or more of said plurality of bilayers of said reflective film.

17. The semiconductor die of claim 14, wherein each of said plurality of bilayers comprises a top layer situated over a bottom layer, wherein said top layer comprises silicon.

18. The semiconductor die of claim 17, wherein said bottom layer comprises molybdenum.

19. The semiconductor die of claim 14, wherein each of said plurality of bilayers has a thickness approximately equal to ½ of a wavelength of EUV light.

20. The semiconductor die of claim 14, wherein said semiconductor die is utilized in a circuit board as a part of an electronic system, said electronic system being selected from the group consisting of a wired communications device, a wireless communications device, a cell phone, a switching device, a router, a repeater, a codec, a LAN, a WLAN, a Bluetooth enabled device, a digital camera, a digital audio player and/or recorder, a digital video player and/or recorder, a computer, a monitor, a television set, a satellite set top box, a cable modem, a digital automotive control system, a digitally-controlled home appliance, a printer, a copier, a digital audio or video receiver, an RF transceiver, a personal digital assistant (PDA), a digital game playing device, a digital testing and/or measuring device, a digital avionics device, a medical device, and a digitally-controlled medical equipment.
